(19) United States
(12) Patent Application Publication
(10) Pub. No.: US 2012/0033976 A1
(43) Pub. Date: Feb. 9, 2012

(54) OPTICAL COMMUNICATION MODULE

(75) Inventor: Yuichi Tagami, Fukuoka-ken (JP)

(73) Assignee: KABUSHIKI KAISHA TOSHIBA, Tokyo (JP)

(21) Appl. No.: 13/194,569

(22) Filed: Jul. 29, 2011

(30) Foreign Application Priority Data
Aug. 3, 2010 (JP) P2010-174287

(51) Int. Cl. H04B 10/00

(52) U.S. Cl. 398/115

(57) ABSTRACT

Provided is an optical communication module including: a surface emitting element configured to convert an electrical signal into an optical signal and emit the optical signal; a lens provided at a predetermined distance from the surface emitting element in a direction along the center of an optical axis of the surface emitting element so that an emission angle from the surface emitting element is 30° or lower, the lens configured to output a first optical signal and a second optical signal; a first polarizing plate provided on the center of an optical axis of the lens, and configured to polarize the first optical signal into a specific direction and pass the first optical signal there through; and a second polarizing plate provided on the center of another optical axis of the lens and adjacently to the first polarizing plate, and configured to polarize the second optical signal at a polarization angle different from that of the first optical signal by approximately 90° and pass the second optical signal there through.

### CROSS-REFERENCE TO RELATED APPLICATION

This application is based upon and claims the benefit of priority from the prior Japanese Patent Application No. P2010-174287, filed on Aug. 3, 2010; the entire contents of which are incorporated herein by reference.

### FIELD

Embodiments of the present invention relate to an optical communication module.

### BACKGROUND

An optical communication module is known which transmits and receives optical signals for data communications through a free space.

In a conventional optical communication module, an optical receiver receives an optical signal and external disturbing light such as sun light or illumination light. However, external disturbing light included in an optical signal adversely influences the performance of an optical transmitter/receiver. For this reason, to improve the performance of the optical transmitter/receiver, there have been developed various methods of increasing an S/N ratio of an optical signal received by the optical receiver by removing the external disturbing light from the optical signal.

Meanwhile, it is known that a light emitting diode (LED) or a surface emitting laser (VCSEL: Vertical Cavity Surface Emitting Laser) is used as a light emitting element for the optical communication module. Particularly, in comparison with an edge emitting-type laser diode, the VCSEL has such features that the drive current is low, that characteristic inspection at a wafer level is possible, and that the two-dimensional arrangement is easy. Accordingly, the VCSEL is widely used as the light source in optical information processing and optical communications.

The VCSEL is used while being sealed in a can package or a resin package to which an optical system such as a lens or an optical fiber is attached. Thus, a laser beam emitted from the VCSEL is transmitted to a receiver module through the optical system such as the lens and the optical fiber. The laser beam, however, has a problem that the intensity of the outer periphery of the laser beam is reduced unless the optical system is positioned accurately in a transmitter module. Particularly, a region which receives a low-intensity laser beam is so susceptible to external disturbing light that the laser beam received therein is unstable.

### BRIEF DESCRIPTION OF THE DRAWINGS

FIG. 1 is a block diagram showing the configuration of an optical communication module according to embodiments.

FIG. 2 is a conceptual diagram for exemplifying a process of extracting a first optical signal S1 from a first optical receiving signal and a second optical receiving signal.

FIG. 3 is a schematic top view of a transmitter module according to a first embodiment seen from the above.

FIG. 4 is a schematic cross-sectional view showing the transmitter module 20 according to the first embodiment.

FIG. 5 is a schematic top view of a receiver module 30 according to the first embodiment seen from the above.

FIG. 6 is a schematic cross-sectional view for illustrating the relationship between an emission angle and the properties of a first lens (second lens) according to the first embodiment.

FIG. 7 is a schematic cross-sectional view showing a first lens (second lens) according to a second embodiment.

FIG. 8 is a schematic cross-sectional view showing a first lens (second lens) according to a third embodiment.

FIG. 9 is a cross-sectional view showing a transmitter module 20 according to a fourth embodiment.

FIG. 10 is a top view of a receiver module 30 according to the fourth embodiment seen from the above.

### DETAILED DESCRIPTION

An optical communication module according to embodiments of the present invention is characterized by including: a surface emitting element configured to convert an electrical signal into an optical signal and emit the optical signal; a lens provided at a predetermined distance from the surface emitting element in a direction of an optical axis of the surface emitting element so that an emission angle of the optical signal from the surface emitting element is 30° or lower, the lens configured to output a first optical signal and a second optical signal; a first polarizing plate provided on the center of an optical axis of the lens, and configured to change the first optical signal in a specific direction and pass the first optical signal therethrough; and further a second polarizing plate provided on the center of another optical axis of the lens and adjacently to the first polarizing plate, and configured to polarize the second optical signal at a polarization angle different from that of the first optical signal by 90°, and pass the second optical signal therethrough.

Hereinafter, embodiments of the invention will be described with reference to the drawing.

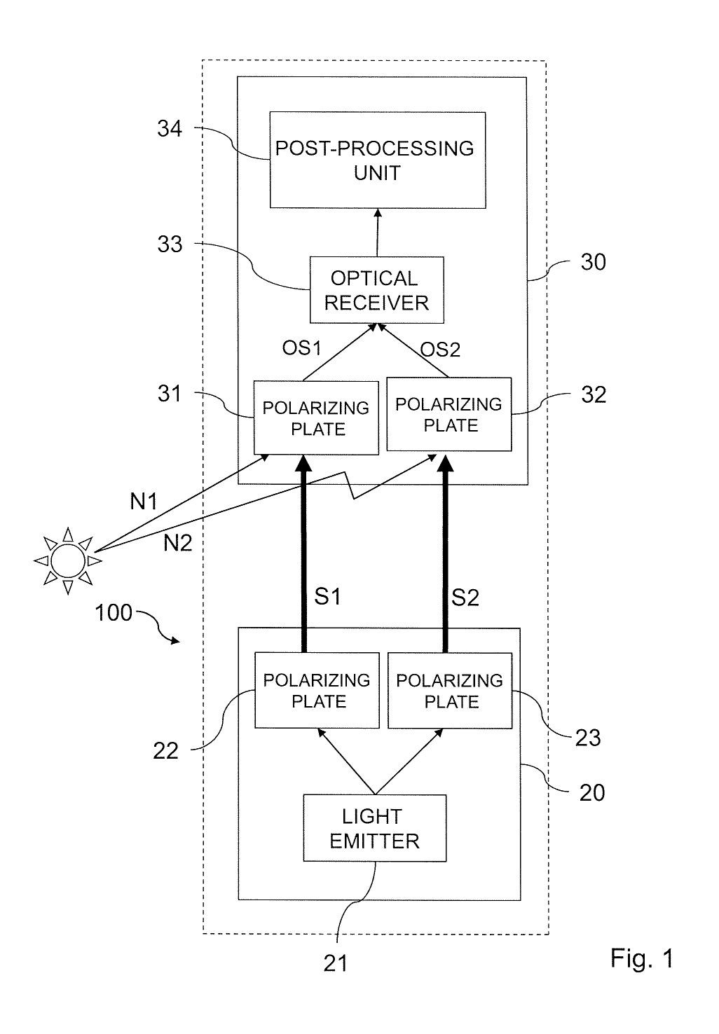

FIG. 1 is a block diagram showing the configuration of an optical communication module 100 according to the embodiments. The optical communication module 100 includes: an optical transmitter module 20 which creates an optical signal and outputs two signals 51 and S2 different from each other in polarization angle; and an optical receiver module 30 which receives the two optical signals S1 and S2 outputted from the optical transmitter module 20 through a light transmission space. In the embodiments, the optical transmitter module and the optical receiver module are provided separately from each other by approximately 10 cm to 1 m.

The optical transmitter module 20 outputs the first optical signal 51 and the second optical signal S2 which are obtained by polarizing an optical signal into specific directions with a first polarizing plate 22 and a second polarizing plate 23, the optical signal being emitted as a laser beam by converting a predetermined current control signal (for example, bias current IBIAS, modulation current IMOD) with a light emitter 21. The first polarizing plate 22 and the second polarizing plate 23 differ from each other in polarization angle by approximately 90°. Thus, the optical transmitter module 20 outputs the first optical signal S1 and the second optical signal S2 which have different polarization angles from each other by approximately 90° and have low interference with each other.

The optical signals inputted into the optical receiver module 30 include external disturbing light N1 and N2 such as indoor lighting and sun light in addition to the first optical signal Si and the second optical signal S2 outputted from the optical transmitter module 20. Hence, the first optical signal Si and the first external disturbing light Ni are inputted into a first receiver polarizing plate 31 of the optical receiver module 30, while the second optical signal S2 and the second external disturbing light N2 are inputted into a second receiver polarizing plate 32.

Since the first external disturbing light N1 and the second external disturbing light N2 are natural light, the oscillation orientation of each component is not fixed, and there is no polarization dependency as a whole. For this reason, the first external disturbing light N1 and the second external disturbing light N2 pass through the respective polarizing plates without any influence.

Moreover, since the first receiver polarizing plate 31 and the second receiver polarizing plate 32 are disposed adjacently to each other, the first optical signal S1 and the first external disturbing light incident on the first receiver polarizing plate 31 can be considered to be equivalent to the second optical signal S2 and the second external disturbing light N2 incident on the second receiver polarizing plate 32. Hereinafter, a signal in which the first external disturbing light N1 is superposed on the first optical signal Si having passed through the first receiver polarizing plate 31 is called a first optical receiving signal OS1, while a signal in which the second external disturbing light N2 is superposed on the second optical signal S2 having passed through the second receiver polarizing plate 32 is called a second optical receiving signal OS2.

After the first optical receiving signal OS1 and the second optical receiving signal OS2 enter an optical receiver 33, the first external disturbing light N1 and the second external disturbing light N2 are removed by a post-processing unit 34. The post-processing unit 34 may further includes an amplifier circuit for amplifying the first optical signal S1 from which the external disturbing light has been removed. In this case, the amplifier circuit may be a circuit using an operational amplifier, or may be a known circuit using known transformer, impedance, and amplifier to reduce a noise.

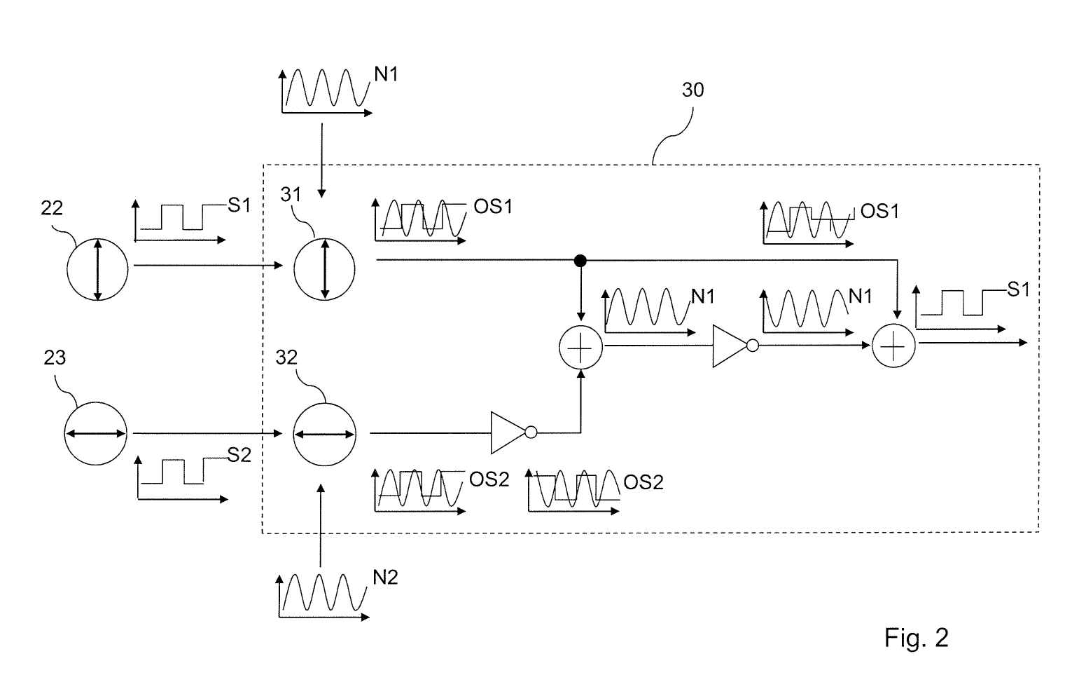

FIG. 2 is a conceptual diagram for exemplifying a process of extracting the first optical signal Si (or the second optical signal S2) by removing the first external disturbing light and the second external disturbing light from the first optical receiving signal OS1 and the second optical receiving signal OS2. In the diagram, an arrow in a circle denotes a polarization direction. The first polarizing plate 22 and the second polarizing plate 23 differ from each other in polarization angle by approximately 90°. Similarly, the first receiver polarizing plate 31 and the second receiver polarizing plate 32 are also polarizing plates that differ from each other in polarization angle by approximately 90°. The first optical signal S1 outputted from the first polarizing plate 22 and the second optical signal S2 outputted from the second polarizing plate 23 are respectively inputted into the first receiver polarizing plate 31 and the second receiver polarizing plate 32, together with the first external disturbing light Ni and the second external disturbing light N2. The optical receiver 33 receives these signals in the form of the first optical receiving signal OS1 and the second optical receiving signal OS2, respectively. Then, the post-processing unit 34 removes the external disturbing light N1 and N2. In the embodiments, the phase of the second optical receiving signal OS2 is inverted, and the first optical receiving signal OS1 is multiplexed with the second optical receiving signal OS2 whose logic has been inverted. Thereby, the first external disturbing light N1 is extracted. After the phase of the first external disturbing light N1 thus extracted is inverted, the first external disturbing light Ni is again multiplexed with the first optical receiving signal OS1 to cancel the first external disturbing light N1. Thereby, the first optical signal S1 is extracted.

### FIRST EMBODIMENT

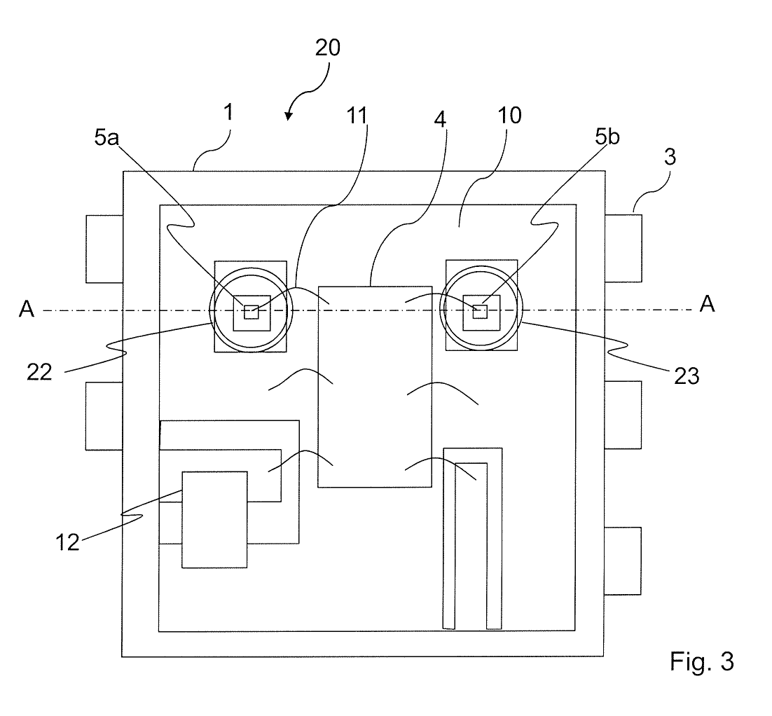

FIG. 3 is a top view of a transmitter module 20 according to a first embodiment seen from the above. As shown in the drawing, on an external light interference 10 within a ceramic board 1 stacked on an electrode terminal 3, surface emitting elements 5a, 5b and a drive circuit 4 are fixed with a conductive adhesive and connected to each other with gold wires 11. Moreover, a microchip capacitor 12 is disposed on the external light interference 10.

The drive circuit 4 is a circuit for controlling the intensity of an optical signal through current control on the surface emitting elements 5a, 5b on the basis of a predetermined current control signal (for example, bias current IBIAS, modulation current IMOD). The configuration of the circuit may be known, as long as the circuit has a frequency characteristic of approximately 3 GHz.

The surface emitting elements 5a and 5b convert an electrical signal created by the drive circuit 4 into an optical signal. The surface emitting elements 5a and 5b may be a VCSEL, for example. The surface emitting element 5a (surface emitting element 5b) emits a laser beam having a frequency corresponding to the transmission distance of the optical signal. When the transmission distance is short, for example, an 850-nm laser beam is outputted. This embodiment includes two surface emitting elements 5a and 5b, as well as polarizing plates 22 and 23 respectively thereabove. The polarizing plates 22 and 23 differ from each other in polarization angle by approximately 90°, as will be described later.

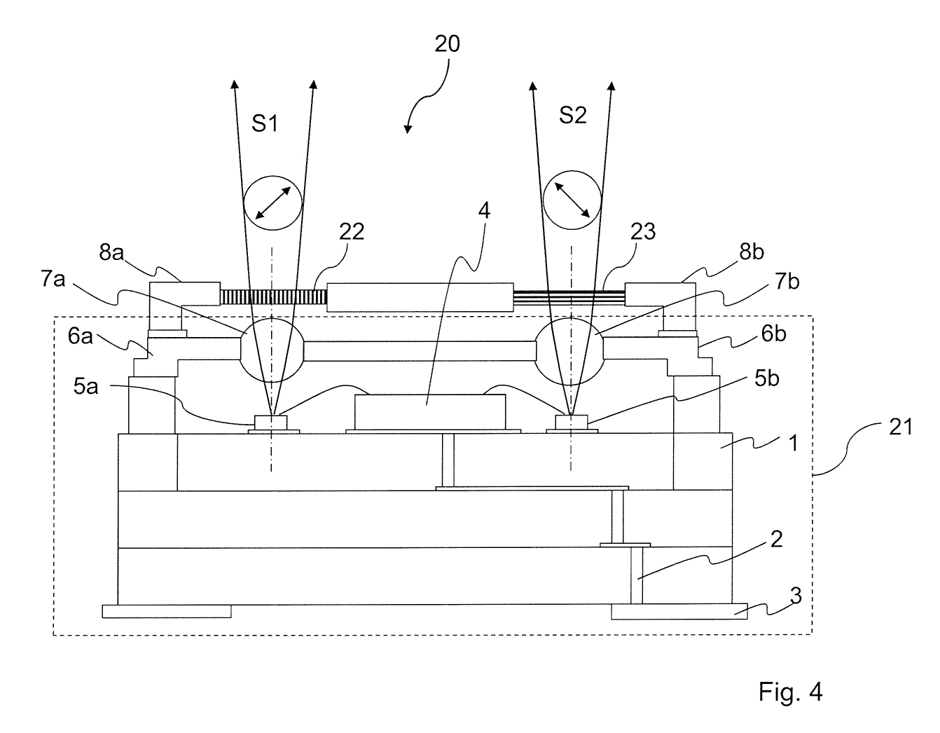

FIG. 4 is a cross-sectional view showing the transmitter module 20 according to the first embodiment, the cross-sectional view showing the section taken along the line A-A in the top view of the transmitter module in FIG. 3. In FIG. 3, a stacked electrical circuit 2 has vias formed in the stacked ceramic board 1, so that each electrode terminal 3 can supply a signal to an unillustrated power supply, ground, and so forth.

As described above, the first surface emitting element 5a and the second surface emitting element 5b are mounted on the electrical circuit pattern of the ceramic board 1 with the conductive adhesive. The drive circuit 4 similarly mounted supplies an electrical signal which is converted into a modulation signal for the first surface emitting element 5a and the second surface emitting element 5b, and then converted into an optical signal by driving the surface emitting elements 5a and 5b. In this case, the modulation is performed with the same signal for the two surface emitting elements.

A first lens 7a and a second lens 7b are attached to the ceramic board 1 with a first cap 6a and a second cap 6b by a method such as electric resistance welding. The first lens 7a and the second lens 7b are optically disposed on the centers of the optical axes of the first surface emitting element 5a and the second surface emitting element 5b, respectively. As will be described later, the properties of the first lens 7a (second lens 7b), such as lens structure, refractive index, curvature, and positional relation to the surface emitting element, are selected in relation to the emission angle and the spot diameter on a receiver module 30.

The first polarizing plate 22 and the second polarizing plate 23 are fixed to a cap with lenses attached to polarizing plate-holding plates 8a, 8b. As described above, the first polarizing plate 22 and the second polarizing plate 23 are set to have polarization angles with an approximately 90° difference to prevent interference of waveforms outputted from both of the polarizing plates. Moreover, each of the polarizing plates is disposed at a position where light spreading on the optical axis of the corresponding surface emitting element and on the optical axis of the lens sufficiently passes. In a case where the first cap 6a and the second cap 6b are not used, the polarizing plates may be fixed on the ceramic board 1 with a UV curable resin or the like.

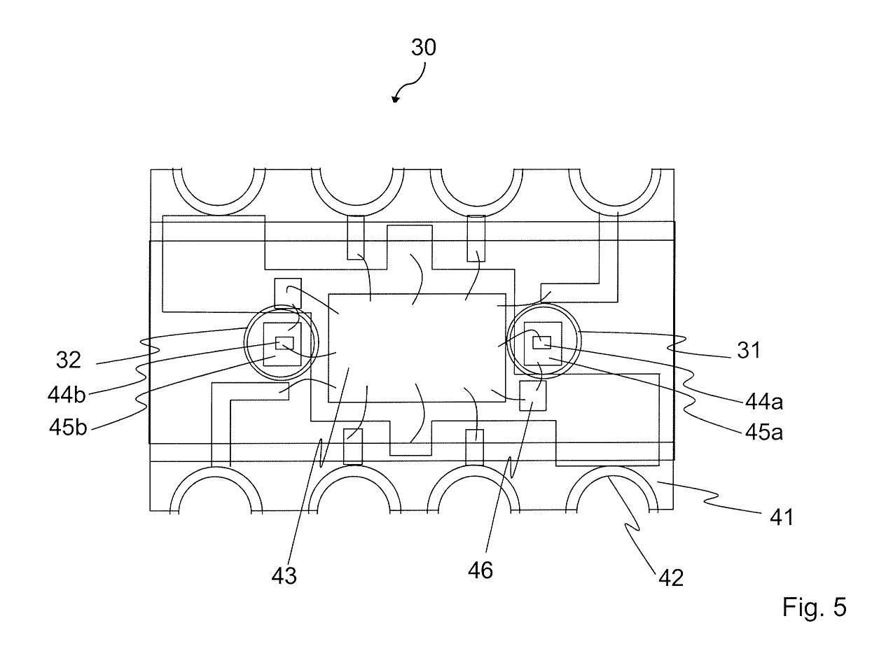

FIG. 5 is a top view of the receiver module 30 according to the first embodiment seen from the above. An electrical circuit and a mount terminal 42 are formed on a glass epoxy board 41. On the electrical circuit pattern, a first light receiving element 44a and a second light receiving element 44b are disposed respectively on insulating bases 45a and 45b for adjusting the height positions, which are made of a material such as a ceramic. The insulating bases 45a and 45b have upper and lower surfaces with a metal film formed thereon, allowing current to flow through wire bonding or the like. In addition, a light-receiving drive circuit 43 which performs amplification or the like on an electrical signal from the light receiving elements having received an optical signal is disposed on the circuit pattern, and connected to the light receiving elements and so forth with gold wires or the like. Note that, as noise measure, a microchip capacitor 46 having upper and lower electrodes is disposed near the light receiving element 44a, the microchip capacitor 46 being formed between top surface and back surface sides. These circuits are further sealed with a trapezoidal structure made of a transparent resin. Moreover, polarizing plates 31 and 32 respectively adhere and are fixed to the first light receiving element 44a and the second light receiving element 44b with a transparent UV curable resin or the like, and specify the polarization directions of light that the light receiving elements receive.

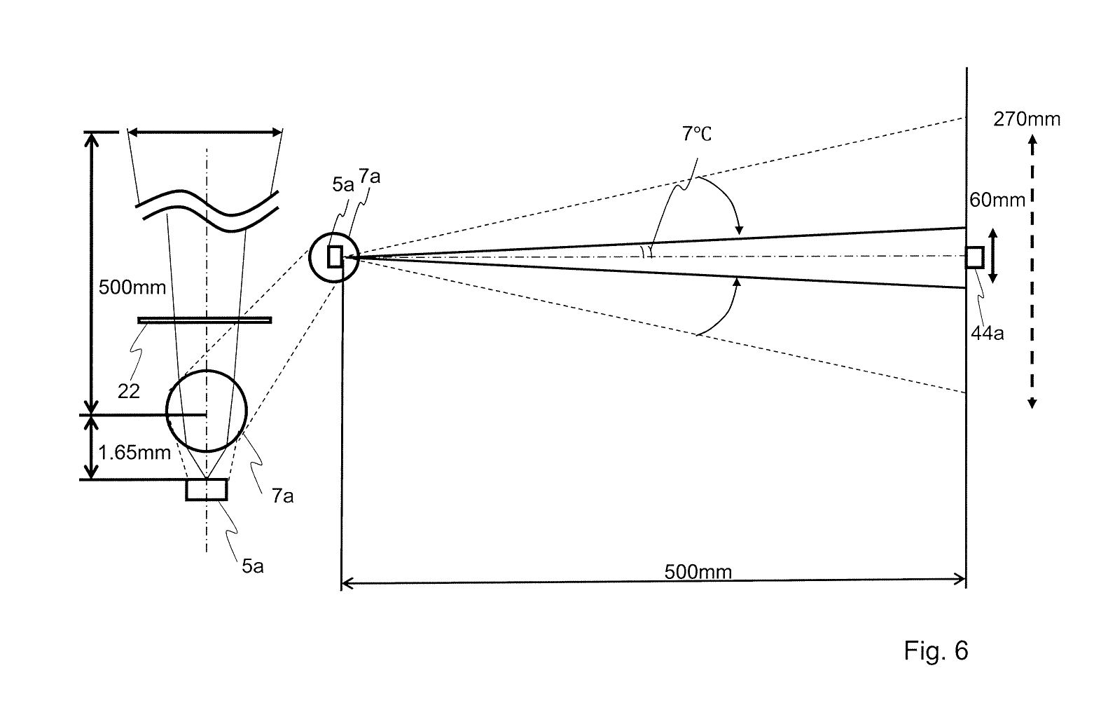

FIG. 6 is a drawing for illustrating the relationship between the properties of the first lens 7a and the emission angle. Hereinafter, only the first lens 7a will be described for the convenience of the description, but the same applies to the second lens 7b. FIG. 6 shows an example in which the first lens 7a having a diameter of 2 mm and a refractive index of 1.55 is provided at a distance of 1.65 mm away from the light emitting surface of the first surface emitting element 5a (second surface emitting element 5b). In this case, the emission angle of light from the first surface emitting element 5a (second surface emitting element 5b) is 30°, and a spot having a diameter of approximately 270 mm is obtained on the light receiving element of the optical receiver module 30 located at a distance of 500 mm the first surface emitting element 5a. Meanwhile, in a case where the first lens 7a having a diameter of 2 mm is provided at a distance of less than 1.65 mm from the light emitting surface of the first surface emitting element 5a (second surface emitting element 5b), the emission angle is 7°, and a spot having a diameter of approximately 60 mm is obtained on the light receiving element of the optical receiver module 30 located at a distance of 500 mm from the first surface emitting element 5a.

As described above, in a case where the refractive index and curvature diameter of a lens used as the first lens 7a are fixed, the emission angle and the spot diameter are decreased as the first lens 7a and the first surface emitting element 5a becomes closer to each other. In addition, if the lens used as the first lens 7a is changed to a lens having a larger refractive index but maintaining the same curvature diameter and position relative to the surface emitting element, the light emission angle and the spot diameter are further decreased. Note that the closer the first polarizing plate 22 is to the first lens 7a, the longer the interval between slits of the polarizing plate 22 becomes. Accordingly, it is more preferable to dispose the first polarizing plate 22 away from the lens 7a. Note that, in this embodiment, the first polarizing plate 22 is disposed above the first lens 7a because of the space in the unit.

As in this embodiment, by appropriately setting the position, the lens diameter, and the refractive index of the first lens 7a (second lens 7b) as well as the positional relation to the first polarizing plate 22 (second polarizing plate 23), a laser beam outputted from the first surface emitting element 5a (second surface emitting element 5b) can be made close to parallel light as much as possible, and the light emission angle and the spot diameter can be decreased. As a result, entering of external disturbing light other than the optical signal outputted from the optical transmitter module 20 can be suppressed, while the laser beam intensity obtained in the optical receiver module 30 is made stable.

### Second Embodiment

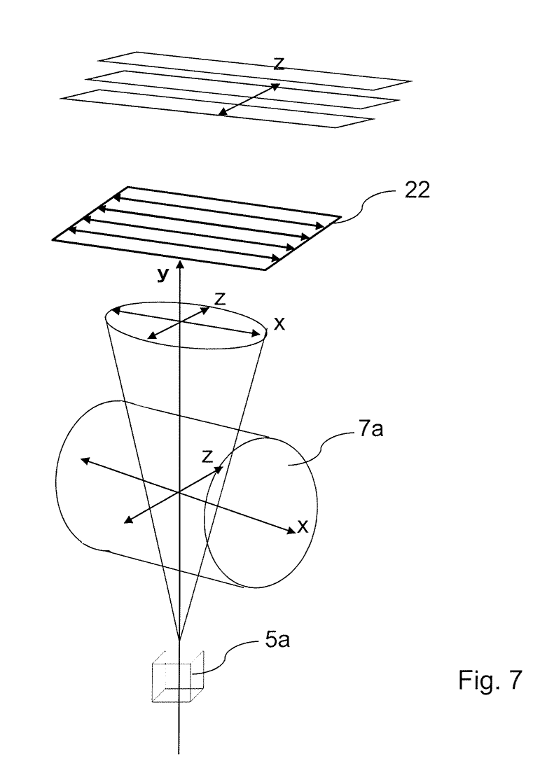

FIG. 7 is a drawing showing a first lens 7a according a second embodiment.

In this embodiment, each of the first lens 7a and a second lens 7b is in a cylindrical shape. The lens effect is obtained in a Z axis direction where the cylindrical axis is set as an X axis direction. A first polarizing plate 22 is provided on a Y axis direction that is a direction along the center of the optical axis of the first lens 7a. The polarization plane of the first polarizing plate 22 is arranged perpendicularly to the Z axis direction where the lens effect is obtained.

By providing cylindrical lenses as in this embodiment, the first polarizing plate 22 serves as a slit, and the emission angle from the first light emitting element 5a is suppressed. Moreover, the percentage of laser beams passing through a slit of a receiver polarizing plate 34 is increased, and the S/N ratio is improved in comparison with a case where the first lens 7a is in a spherical shape with its planar surface parallel to the polarizing plate.

### Third Embodiment

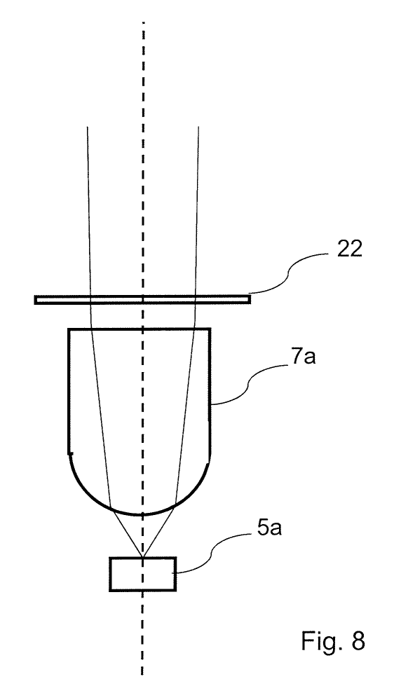

FIG. 8 is a drawing showing a first lens 7a according a third embodiment.

In this embodiment, as the first lens 7a, a rod lens (registered trademark) is used. The rod lens is a rod-shaped gradient index lens obtained by cutting an optical fiber having a refractive index distribution in a radial direction into a certain length.

By using the rod lens as the first lens 7a, a first optical signal behaves more like parallel light in an optical receiver module 30.

### Fourth Embodiment

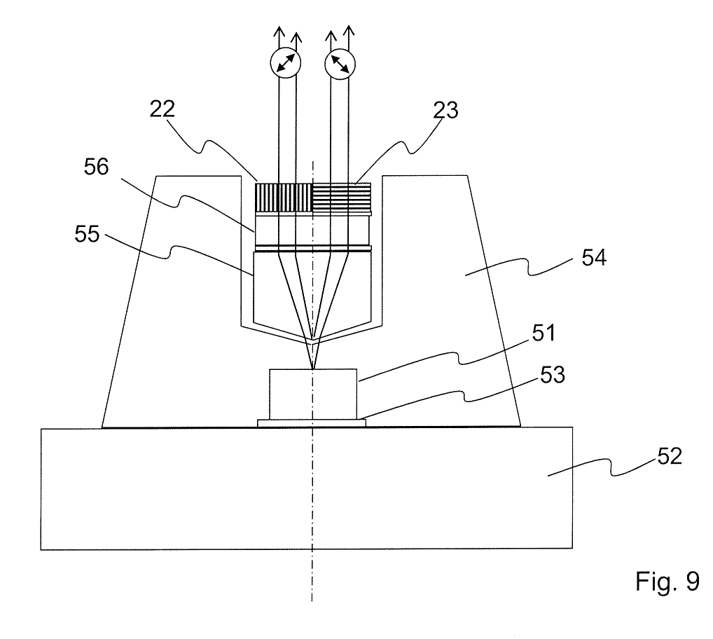

FIG. 9 is a cross-sectional view of a transmitter module 20 according to a fourth embodiment. In this embodiment, a single light emitting element 51 is mounted on a glass epoxy board 52 and fixed thereto with a conductive epoxy 53. Moreover, the surface emitting element 51 is connected to a drive IC, and has a structure capable of converting an electrical signal into an optical signal (unillustrated). The top surface of the surface emitting element 51 is sealed with a transparent epoxy resin 54 on the glass epoxy board 52, and a portion of the transparent epoxy resin 54 near the surface emitting element 51 is thin.

Lenses 55 and 56 according to this embodiment are provided above the thin portion, that is, on the center of the optical axis of an optical signal outputted from the surface emitting element 51. The lenses 55 and 56 collect the optical signal emitted from the surface emitting element 51. Specifically, a microprism lens is disposed as the lens 55, which branches the optical signal. Similarly, a prism lens as the lens 56 corrects the optical axis directions thereof, and guides the optical signals to polarizing plates 22 and 23.

Each of the polarizing plates 22 and 23 is provided at a position where light spreading on the optical axis of the surface emitting element 51 and on the optical axes in the lenses sufficiently passes. The polarizing plates 22 and 23 differ from each other in polarization angle by 90°.

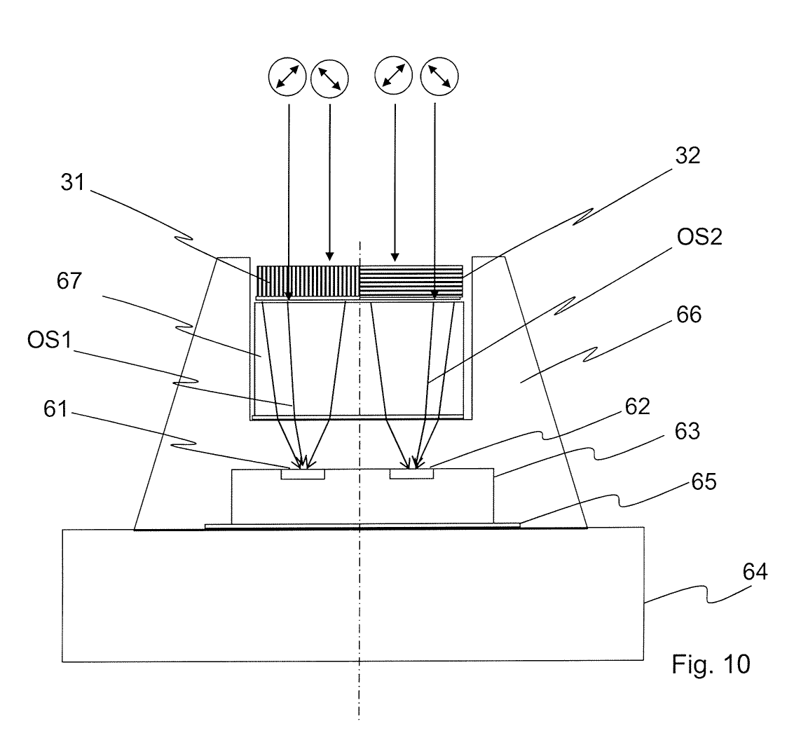

FIG. 10 is a cross-sectional view showing an optical receiver module according to the fourth embodiment. As shown in FIG. 10, two light receiving elements 61, 62 are integrally formed with a light receiving circuit 63. The light receiving elements convert an optical signal received by the light receiving elements into a current. Furthermore, the light receiving elements perform amplification, demodulation, and so forth on the electrical signal. The light receiving circuit 63 is mounted on a glass epoxy board 64 and fixed thereto with a conductive epoxy 65, and sealed with a transparent epoxy resin 66 on the glass epoxy board 64. A portion of the transparent epoxy resin 66 near the light receiving circuit 63 is thin.

In this embodiment, a microprism lens as a lens 67 is disposed at the thin portion, and a first receiver polarizing plate 31 and a second receiver polarizing plate 32 are fixed thereon. Similarly to the optical transmitter module 20, the polarization angle difference of 90° and the polarization direction are set so that two kinds of polarized optical signals emitted from the transmitter side can be received separately. The lens 67, the first receiver polarizing plate 31, and the second receiver polarizing plate 32 are fixed with a transparent UV curable adhesive or the like. In addition, these polarizing plates can be made more compact by being formed with a photonic crystal. The prism lenses and the like may also be formed using a photonic crystal.

With such a structure, when a first optical receiving signal OS1 and a second optical receiving signal OS2 emitted from the transmitter side enter simultaneously, only an optical signal that corresponds to one of the polarization angles reaches the prism lens 67 and is thus collected.

As in this embodiment, optical signals of two polarization angles from a single surface emitting element can be received by the optical receiver module 30. In this manner, by providing a single surface emitting element, not only can the number of components be reduced, but also influences of individual differences among surface emitting elements such as laser beam intensity and emission angle are eliminated. Thus, the S/N ratio in the optical receiver module 30 is improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An optical communication module comprising:
a surface emitting element configured to convert an electrical signal into an optical signal and emit the optical signal;
a lens provided at a predetermined distance from the surface emitting element in a direction along the center of an optical axis of the surface emitting element so that an emission angle from the surface emitting element is 30° or lower, the lens configured to output a first optical signal and a second optical signal;
a first polarizing plate provided on the center of an optical axis of the lens, and configured to polarize the first optical signal into a specific direction and pass the first optical signal therethrough; and
a second polarizing plate provided on the center of another optical axis of the lens and adjacently to the first polarizing plate, and configured to polarize the second optical signal at a polarization angle different from that of the first optical signal by approximately 90°, and pass the second optical signal therethrough.

2. The optical communication module according to claim 1, further comprising:
a first receiver polarizing plate configured to polarize the first optical signal and pass the first optical signal therethrough;
a second receiver polarizing plate provided adjacently to the first receiver polarizing plate, and configured to polarize the second optical signal at a polarization angle different from that of the first optical signal by approximately 90°, and pass the second optical signal therethrough; and
an optical receiver configured to receive the first optical signal and the second optical signal.

3. The optical communication module according to claim 1, wherein the lens is a prism lens.

4. The optical communication module according to claim 1, further comprising:
a second surface emitting element configured to convert the electrical signal into the optical signal and emit a second optical signal at a predetermined emission angle; and
a second lens provided on the center of an optical axis of the second surface emitting element so that the emission angle of the second optical signal from the second surface emitting element is 30° or lower, the second lens configured to pass the second optical signal therethrough and output the second optical signal to the second polarizing plate.

5. The optical communication module according to claim 1, wherein the lens is in a spherical shape.

6. The optical communication module according to claim 1, wherein the lens is a rod-shaped gradient index lens obtained by cutting an optical fiber having a refractive index distribution in a radial direction into a certain length.

7. The optical communication module according to claim 4, wherein
the first lens is in a cylindrical shape, and an axis direction of the cylindrical shape is arranged parallel to a polarization plane of the first polarizing plate, and
the second lens is in a cylindrical shape, and an axis direction of the cylindrical shape is arranged parallel to a polarization plane of the second polarizing plate.
